(19) United States
(12) Patent Application Publication
(10) Pub. No.: US 2019/0330049 A1
(43) Pub. Date: Oct. 31, 2019

(54) NOODLE FILLER AND APPARATUS FOR MAKING SAME

(71) Applicant: Nicholas Sama, Cutlet Bay, FL (US)

(72) Inventor: Nicholas Sama, Cutlet Bay, FL (US)

(21) Appl. No.: 14/030,014

(22) Filed: Sep. 18, 2013

(51) Int. Cl. B68G 7/06

(52) U.S. Cl. CPC B68G 7/06; A47C 27/14

(57) ABSTRACT

A filling for frameless furniture is provided that vastly increases the positional stability of the filling by being comprised of high aspect ratio particles that contact and interlock with many more nearby particles than can be accomplished by substantially mono-dimensional prior art particles. The invention further features a process and apparatus for the manufacture of the high aspect ratio particles that provide substantial advantages over the prior art. Included in the advantages are uniformity of support, minimizing voids without support, and lack of resiliency from clustering, clumping and dense packing, all of which result from size disparity of prior art filling that is made rather crudely by foam shredding machines. The invention further includes an apparatus for fabricating the filler.

### FIELD OF THE INVENTION

The present invention relates to the field of frameless furniture which also commonly referred to as bean bag furniture although it is not normally made any longer with polystyrene beans. Specifically it relates to filling that is used to fill the bags that form the furniture. The particular filling in this instance is designed specifically to ensure uniform distribution of support by avoiding a clustering or clumping of the filling which in turn minimizes voids that lack support. That is possible because the shape of the particles has a dramatic effect on the support the filling provides.

In the recent past, filling for frameless furniture has been made of shredded, flexible, mostly open-celled urethane foam which is produced by running the foam through a mechanical shredder. Such a process yields particles over a wide range of sizes and of more or less mono-dimensional, i.e., particles that are substantially all approximately one dimension and may approach a sphere (spheroidal shape). The effect of mono-dimensional filling is that each particle can only contact other particles that are immediately adjacent thereto. On this connection mono-dimensional refers to the dimensions within a given particle—it does not mean to reflect a comparison of one particle to another. In fact, prior art particles vary in size to each other and this characteristic contribute to voids and related problems in prior art filling. Put another way, the spheroidal, shape gives rise to a serious support problem: considered overall, a mass of such particles has little integrity, because the spheroidal shape generally precludes any more than single point (single small area) contact between any two of them. This in turn results in the filler separating under (squirming) load and so to a loss of adequate support.

The noodle shape herein described, by contrast, produces a filler that mostly eliminates separation. By blowing the particles into a flexible container, they will crisscross randomly to produce a three-dimensional array which, by the mutual snagging of the particles at their numerous points of contact, gives it a considerable overall integrity.

The filling of the present invention is dimensioned with an aspect ratio in which two of the dimensions are substantially small and somewhat equal while the third dimension is a considerable multiple of the other two such that each particle can interact and interlock with a considerable plurality of nearby particles that may or may not be immediately adjacent. This dimensioning of the particles forming the filling of the present invention is referred to as high aspect ratio particles (“H.A.R. particles”).

The aspect ratio Is created by cutting apparatus that is the apparatus portion of the present invention. Assuming that the raw material is scrap poly urethane foam having one dimension no greater than four inches, the apparatus operates through a feeding conveyer to a shear set of rollers that cuts the raw material into slabs having a thickness of approximately ⅜ of inch. Thereafter, the slabs orient themselves by gravity into a flattened configuration and then pass through a second set of shearing rollers that provides a second dimension approximately equivalent to the first dimension. This is called the stripping cutter. After the stripping cutter, the strips are cut using a spiral rotating blade in conjunction with anvil that end cuts the strips to the desired aspect ratio in the range of six to sixty. This longer dimension produces a shape that can be characterized as a noodle.

### DESCRIPTION OF THE PRIOR ART

Resilient aggregate of various kinds has long been used as filling for pillows, and the like, to produce comfortable rest aids. In recent years, the advent of foams made from plastic resins has much expanded the range of aggregates available for such use. Of special importance are foams made from polyurethane, since they are non-allergenic, relatively inexpensive, lightweight, and can be formulated in a wide range of weights and resiliencies; and, lately, with viscoelastic properties.

The usual way of producing filling from such foams in the prior art is by putting them through a mechanical shredder, which reduces the particles to a range of sizes depending on the shredder and the number of passes through which they are put. Such shredding of foams results in (1) the particles being almost all of a roughly oval or spherical shape, and (2) a wide variation in size. These lead, in turn, to two undesirable characteristics of the filling: (1) because of their shape, entanglement between the particles is very small, so that under load the filling tends to separate beneath the load and thus badly reduce support; and (2) their wide variation in size results in an undesirably dense packing and reduction of resilience, especially after a time. The reason is that the smaller particles fill the voids between the larger particles and thus result, overall, in a denser packing.

The present invention much reduces or eliminates these undesirable characteristics. By forming the particles in the shape of “noodle” (two substantially equal minor dimensions and a larger major dimension) and of a narrow range in sizes, a much better filling mass is achieved: the noodle shape results in significant entanglement of the particles and thus eliminates separation, while the narrow size range reduces the dense packing.

Regarding the noodles, it has been found that an effective entanglement is achieved by forming them such that the ratio of their major dimension to their minor dimensions (the “aspect ratio”) is in the range of six (6) to sixty (60). The size is essentially open since it depends on what the filling is intended to support, but the size ratio between the particles should be maintained relatively small and constant to prevent dense packing; ideally, it should be kept close to one (1).

So far as presently known to this inventor, there is no prior art in the patent literature specifically directed to frameless furniture filling. The closest known exception to that is inferential descriptions in such references as U.S. Pat. Nos. 6,279,184 and 6,732,391 wherein the filling is described as “a plurality of polyurethane foam pieces retained within the outer liner.” It is clear from the description and drawings of these references that the filling is comprised of a multiplicity of substantially mono-dimensional material concerning which no efforts seem to have been made to effect uniform support and the absence of voids.

### SUMMARY OF THE INVENTION

Bearing in mind the foregoing, it is a principal object of the present invention to provide a frameless furniture filling which provides for an uniformity of support and minimizes voids.

It is a related principal object of the invention to utilize in frameless furniture a filling that is not more or less mono-dimensional so that each particle of the filling obtains retentive capability from other particles that mostly are not immediately adjacent to it.

Another related object to the invention is to cause interlocking of the filling particles by dimensioning the particles with an aspect ratio in which two of the dimensions are substantially small and somewhat equal while the third dimension is a considerable multiple of the other two such that each particle can interact and interlock with a considerable plurality of nearby particles that may or may not be immediately adjacent.

An additional related object of the invention is to cause each particle to have a greatly increased positional stability because each particle has not only the adjacent particles if it were mono-dimensional to hold it in place, but many more nearby particles with which it would not be in contact except for the high aspect ratio (H.A.R.) of its dimensions.

A further principal object of the present invention is to provide an apparatus that takes typical waste polyurethane foam as raw material and cuts it into H.A.R. particles.

Other objects and advantages will become apparent to those skilled in the art upon reference to the following descriptions and the appended drawings as described hereinafter.

In accordance with a principal modality of the present invention there is provided a filling for frameless furniture that vastly increases the positional stability of the filling by being comprised of high aspect ratio particles which contact and interlock with many more nearby particles than can be accomplished by substantially mono-dimensional particles of the prior art.

In accordance with a secondary modality of the present invention there is provided a cutting apparatus that cuts the raw material into slabs having a thickness of approximately ¾ of inch.

Thereafter, the slabs orient themselves by gravity into a flattened configuration and then pass through a second set of shearing rollers that provides a second dimension approximately equivalent to the first dimension. This is called the stripping cutter. After the stripping cutter, the strips are cut using a spiral rotating blade in conjunction with anvil that end cuts the strips to the desired aspect ratio in a range to six to sixty.

### BRIEF DESCRIPTION OF THE DRAWINGS

Various other features of the invention will become apparent to those skilled in the art from the following discussion taken in conjunction with the appended drawings, in which:

FIG. 1 is a perspective view of the preferred embodiment of the high aspect ratio filler of the present invention showing how the particles extend beyond the immediately adjacent particles to facilitate interlocking of the particles for optimum positional, stability.

FIG. 2 is a schematic drawing showing the sequence of the principal components in the apparatus for making the high aspect ratio filler of FIG. 1.

FIG. 3 is a broken cross sectional view taken along the lines 3(a) and 3(b) of FIG. 2 showing the shearing rollers of the slabbing cutter and the stripping cutter.

FIG. 4 is a broken top plan view of the spiral rotating blade and supporting roller, which spiral blade in combination with an anvil (see FIG. 2) cuts the resulting strips into high aspect ratio noodle type particles.

FIG. 5 is a perspective view of the post spiral blade cutter components comprised primarily of a centrifugal fan, tubing, and a storage bag.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

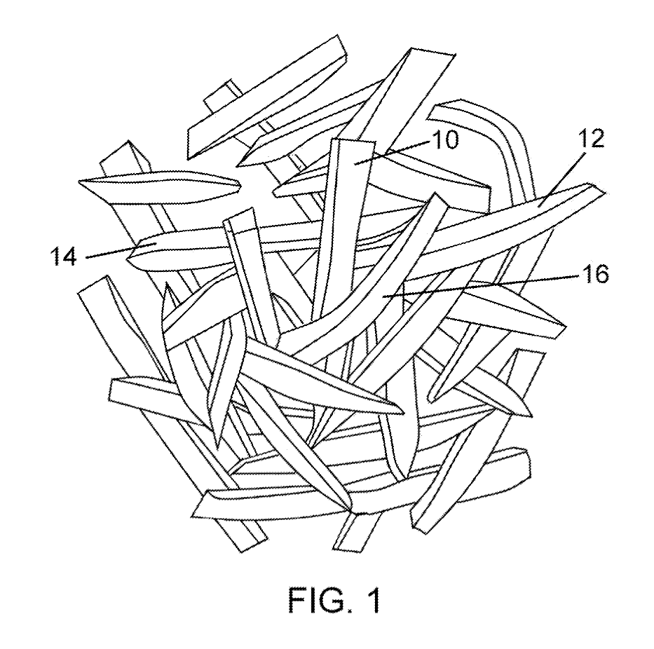

FIG. 1 is a perspective view of the preferred embodiment of the high aspect ratio filler of the present invention showing how the particles 10 extend beyond the immediately adjacent particles 12, 14, and 16 to facilitate interlocking of the particles for optimum positional stability.

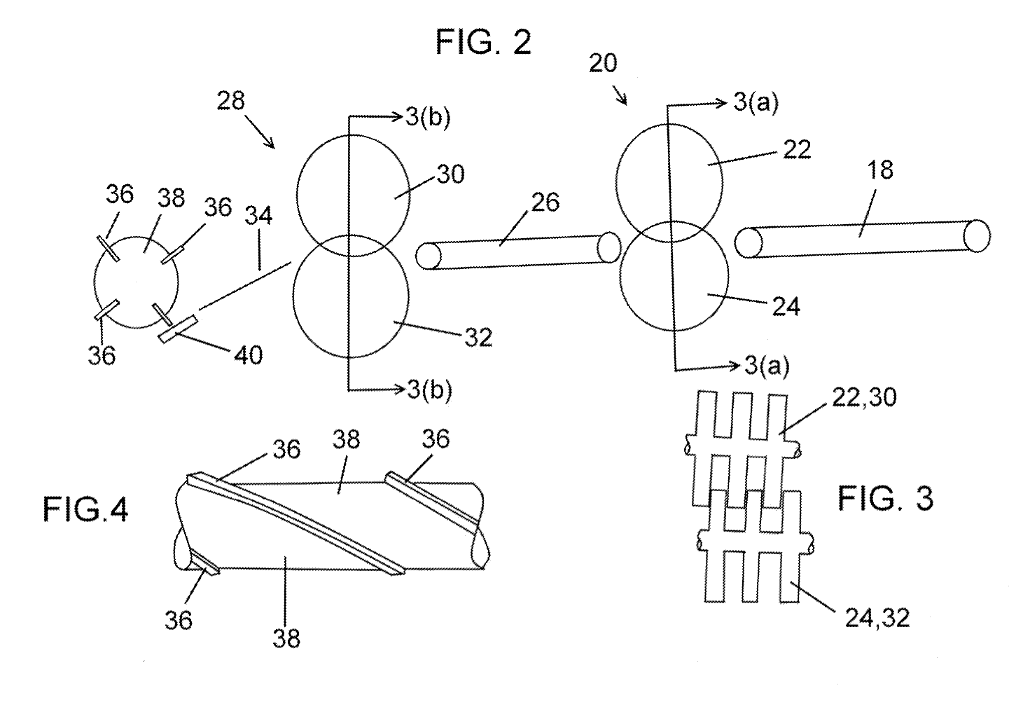

FIG. 2 is a schematic drawing showing the sequence of the principal components in the apparatus for making the high aspect ratio filler 10, 12, 14, 16 of FIG. 1. Raw material is fed onto first moving conveyor 18 and is delivered thereby to slabbing cutter 20 comprised of shear rollers 22 and 24. The result is slabs of urethane foam that are delivered to second moving conveyor 26. While on second moving conveyor 26, the slabs fall into a more or less horizontal configuration by reason of gravity, and are delivered to stripping cutter 28. Stripping cutter 28 is comprised of shear rollers 30 and 32. The result of stripping cutter 28 is that the raw material is now cut into strips that roughly have a square cross section. These strips slide or are moved by a third moving conveyor 34 to spiral rotating blades 36 mounted on supporting roller 38. Spiral rotating blades 36 cooperate with anvil 40 to cut the strips into high aspect ratio particles or noodles. The speed of the spiral rotating blades 36 are adjusted by controlling the rotational speed of supporting roller 33, resulting in a high aspect ratio of the noodles that optimally vary from 6 to 60.

FIG. 3 is a broken cross sectional view taken along the lines 3(a) and 3(b) of FIG. 2 showing the shearing rollers 22, 24 and 30, 32 of the slabbing cutter 20 and the stripping cutter 28.

FIG. 4 is a broken top plan view of the spiral rotating blades 36 and supporting roller 38, which spiral blades in combination with an anvil 40 (see FIG. 2) cuts the resulting strips into high aspect ratio noodle type particles.

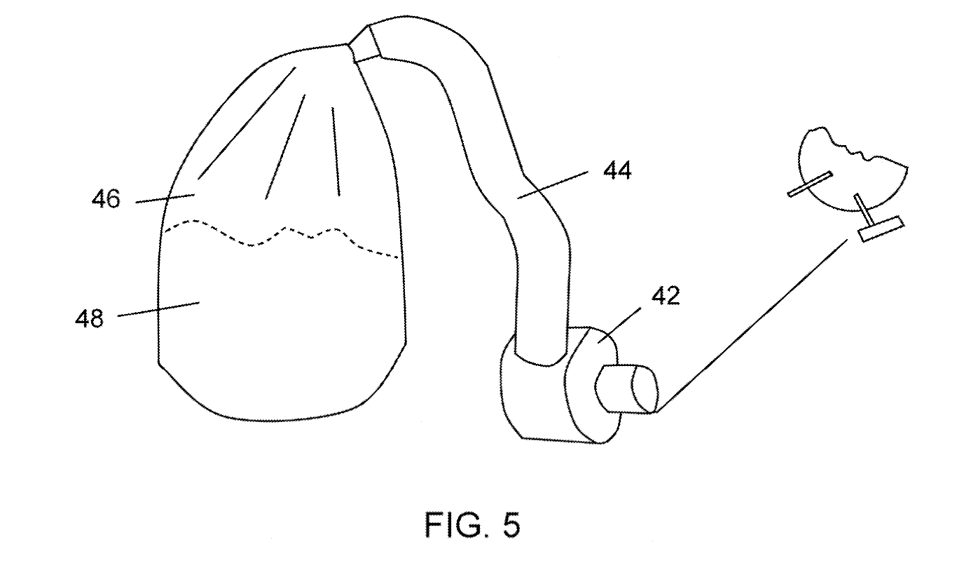

FIG. 5 is a perspective view of the post spiral blade cutter components comprised primarily of a centrifugal fan 42, tubing 44, and a storage bag 46, containing high aspect ratio filler 48.

While the Invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fail within the breadth and scope of the claims here appended.

1.-20. (canceled)

21. A filler for furniture comprising resilient particles having a high aspect ratio in which each said particle interacts with a plurality of other particles beyond those adjacent to said particle.

22. The filler of claim 21 in which high aspect ratio means a particle in which two of the three dimensions of the particle are substantially equal to each other and small compared to the third dimension, while the third dimension is a multiple of the other two dimensions such that each such particle has a reach to interlock with particles beyond those particles that are adjacent to said particle.

23. The filler of claim 22 in which high aspect ratio results in each such particle achieving substantially increased positional stability when compared to largely mono-dimensional particles of the prior art.

24. The filler of claim 23 in which the high aspect ratio results in more uniformity of packing than prior art filler since it counters a tendency from disparity of, size of prior art particles to over time cause undesirably dense packing, and reduction of resilience because smaller prior art particles fill voids between larger prior art particles.

25. The filler of claim 24 in which its more uniform packing than the prior art filler counters a tendency from disparity of packing of prior art filler that over time causes clustering or clumping and voids that reduce support with the prior art filler.

26. The filler of claim 24 in which uniformity of particle size is limited to the two small dimensions and the aspect ratio is random over the range of 6 to 60.

27. The filler of claim 21 in which furniture includes frameless furniture, bean bag furniture, cushions, pillows, conventional furniture with frames, hassocks, footstools, vehicular furniture, and all other furniture accessories.

28. A filler for furniture comprising particles having at least one dimension that facilitates each particle interlocking with a plurality of other particles not adjacent to said particle.

29. The filler of claim 28 in which each such particle achieves substantially increased positional stability when compared to largely mono-dimensional particles of the prior art.

30. The filler of claim 28 in which each such particle achieves more uniformity of packing than the prior art particles because each such particle is made by a method which controls the size of each dimension as opposed to the mechanical shredder means of making of such prior art fillers that results in a disparity of sizes of prior art particles.

31. The filler of claim 30 in which its more uniform packing than prior art filler counters a tendency from disparity of packing of prior art particles that over time cause undesirably dense packing and reduction of resilience because the smaller prior art particles 11 voids between larger prior art particles.

32. The filler of claim 30 in which its more uniform packing than prior art filler counters a tendency from disparity of packing of prior art filler that over time causes clustering or clumping and voids that lack support.

33. The filler of claim 28 in which furniture includes frameless furniture, bean bag furniture, cushions, pillows, conventional furniture with frames, hassocks, footstools, vehicular furniture, and all other furniture accessories.

34. A filler for furniture comprised of noodle-shaped resilient material blown into a flexible container whereby the noodles crisscross each other in a random manner and mutually snagging at many points of contact, there results an array having considerable resistance to separation under squirming load, and thus provides superior support.

35. The filler of claim 34 in which each such noodle achieves substantially increased positional stability when compared to largely mono-dimensional particles of the prior art.

36. The filler of claim 35 in which each such noodle achieves more uniformity of packing than the prior art particles because each such noodle is made by a method which controls the size of each dimension as opposed to the mechanical shredder means of making of such prior art fillers that results in a disparity of sizes of prior art particles.

37. The filler of claim 36 in which its more uniform packing than prior art filler counters a tendency from disparity of size of prior art particles that over time cause undesirably dense packing and reduction of resilience because the smaller art particles fill voids between larger prior art particles.

38. The filler of claim 36 in which its more uniform packing than prior art filler counters a tendency from disparity of size of prior art filler that over time causes clustering or clumping and voids that lack support with prior art filler.

39. The filler of claim 34 in which furniture includes frameless furniture, bean bag furniture, cushions, pillows, conventional furniture with frames, hassocks, footstools, vehicular furniture, and all other furniture accessories.
